(19) United States
(12) Patent Application Publication
(10) Pub. No.: US 2007/0293142 A1
(43) Pub. Date: Dec. 20, 2007

(54) Secure Contactless Communication Device and Method

(75) Inventors: Francois Dehmas, Meylan (FR); Elisabeth Crochon, Poisat (FR); Francois Vacherand, Le Pont de Claix (FR)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUE, Paris (FR)

(21) Appl. No.: 11/575,872

(22) PCT Filed: Sep. 26, 2005
(86) PCT No.: PCT/FR05/50779

§ 371 Date: Mar. 23, 2007

(30) Foreign Application Priority Data
Sep. 27, 2004 (FR) 0452171

(51) Int. Cl. H04K 1/02

(52) U.S. Cl. 455/1

(57) ABSTRACT

A method for secured communication between a transmitter (10) and a receiver (1) in which a range of power levels transmitted by the transmitter (10) a range of frequencies inside which the transmission will occur, (10) are known or detectable by the receiver (1), the method including
transmission by the receiver (1) of a power supply signal for the transmitter characterized in that the receiver (I) transmits for at least the whole duration of the transmission, a noise signal which buries the transmission signal,
the receiver (1) subtracts from the received signal, the noise signal in order to obtain a useful signal. The invention also includes a receiving device operating according to the method.

### TECHNICAL FIELD

The invention relates to a device and method for remote transmission in particular for portable objects (of the card, ticket, label type, etc.) linked by coupling, for example inductive coupling, with a fixed station (of the card reader, label requester types etc.).

The invention is in particular directed to a device including a transmitter and a receiver between which a secured transmission is provided. It is more particularly but not exclusively directed to the case when the transmitter is a transmitter of a chip card and when the receiver is a chip card reader.

It finds applications in all the fields of contactless data exchanges, by coupling, for example according to a non-limiting list between a portable object and a fixed station and, in particulars in the field of identification of things or objects in the field of access controls for example for computer services, or in the field of card toll payment.

### STATE OF THE PRIOR ART

Patent FR 2 776 865 granted to the present applicant, discloses a communications system between a transmitter of a card and a receiver illustrated in FIG. 1.

A data exchange system includes a receiver 1 for example a card reader and one or more transmitters 10 mounted on portable objects. The receiver 1 includes a frequency generator 2, for example an oscillator, coupled in series with a load impedance rA and a tuned circuit 6. The tuned circuit 6 includes a capacitive impedance 5, an inductive impedance 3 in series. A detection circuit 9 which includes detection means illustrated as a diode 7 for example coupled capacitively to amplification and processing circuits 8, is coupled in parallel with the tuned circuit 6.

The transmitter 10 of the portable object includes a set of electronic circuits 11 connected to the terminals of a resonant circuit 19, for example as a capacitor 13 connected in parallel to an inductive coil 12.

In operation, the transmitter 10 of the portable object and the receiver circuit 1 are inductively coupled with each other through their respective inductive load, 3, 12.

The transmitter 10 of the portable object is for example remotely powered from the source 2. This case is often encountered for card readers.

A change in coupling is obtained by varying a load impedance 18b placed in series or as illustrated in FIG. 1 in parallel with the resonant circuit 19. The changes in the load impedance 18b and therefore in the coupling are detected in the receiver 1. Thus, by controlling the value of the load impedance 18b, it is possible to transmit data from the transmitter 10 to the receiver 1.

A more detailed embodiment of the transmitter 10 of the portable object described in the aforementioned patent is illustrated in FIG. 2. Like in the example of FIG. 1, the transmitter 10 of the portable object includes an inductive component forming an antenna 12, for example a conducting coil at the terminals of which a capacitor 13 is connected, thereby forming a resonant circuit 19. A voltage rectifier 15 is mounted in parallel on the terminals of the antenna 12 in order to provide transformation of the alternating voltage received by the antenna 12 into a DC voltage, transported through a power supply line Vdd towards the processing and storage means 14 not shown.

The rectifier 15 is a GRAETZ bridge connected to both terminals of the coils 12 through connection points 15a and 15c. A connection point 15b of the rectifier is directly connected to an output line Vss of the transmitter 10 of the portable object.

A connection point 15d of the rectifier 15 is connected to an input 18c of a modulator circuit 18. The modulator 18 includes an electronic dipole 18b mounted in parallel on a switching transistor 18a. This switch 18a and dipole 18b assembly is mounted in series on the power supply line Vdd, between an output point Vr of the rectifier 15 and an input point Vs of a differential amplifier 16b. The applied voltage at this input Vs relatively to the point Vss is the regulated voltage Vdd.

The electronic dipole 18b of the modulator 18 is selected so as to introduce a voltage drop Vr−Vdd between points 18c and 18d of the modulator 18, when the transistor 18a is open. When the transistor 18a is closed, the voltage drop introduced by the modulator 18 should be lower and preferably negligible.

In the embodiment described above, the electronic dipole 18b is a component with a non-linear current-voltage characteristic, such that the voltage on its terminals is practically constant, with which a modulation depth of the quality coefficient of the portable object may be maintained at a practically constant value.

The electronic dipole 18b may be a resistor or a diode, or a ZENER diode, or even a transistor in which the gate is connected to the drain. The electronic dipole 18b may also consist in a plurality of diodes associated in series. The components 14-18 form together the electronic circuit 11 illustrated in FIG. 1.

Digitally encryption of the response of the transmitter 10 to the receiver 1 is known, by means of a key known to the receiver and which is used for decrypting the received encrypted message.

Encryption of the data sent by the transmitter requires that a certain number of operations be performed. This number may be significant as in the case of RSA (Rivest, Shamir, Adleman) encryption. Further, certain encryption algorithms require storage of a key which may be found by a third partly by a DPA (Differential Power Analysis) attack.

### DISCUSSION OF THE INVENTION

The object of the invention is to propose a method and a device with which detection of the message sent by the transmitter and received by the receiver may be made more difficult.

With the inventive object of the present invention, the transmitter may not perform any encryption calculation and may transmit clear text. The cost and size of the transmitter are thereby reduced since it is no longer necessary to provide key storage means and encryption means. There is no longer any risk of detection of a key by intrusion, which might jeopardize the security of the communication.

Further, even if a communication is recorded, its subsequent replaying would be absolutely useless as the receiver would not be able to understand this copy.

During a communication without any physical contact between the transmitter and the receiver, an intruder may intercept the exchanged signals. According to the invention, the receiver scrambles the signals transmitted by the transmitter so that only the receiver may decode the received signals.

The main idea is that the receiver will create a perturbation scrambling the signals transmitted by the transmitter. It will then be able to recover the signal sent by the transmitter by elimination on the received signals, the effects of the perturbation which it has created.

The diagram of FIG. 3 describes the basic principle.

In FIG. 3, between the transmitter 10 and the receiver 1, a channel C is materialized, through which a signal s delivered by said transmitter 10 and a noise signal b transmitted by the receiver transit. Signal s is a data signal obtained by modulating a parameter of a carrier frequency of the signal s, for example the amplitude, the frequency or the phase. The noise b scrambles the signal a sent by the transmitter. The scrambling noise relates to the same parameter as the one for which the modulation is used for transmitting the useful signal a. Channel C does not have any physical existence; it is the space between the transmitter and the receiver. In the case of a card reader, this is the space provided in the reader for inserting the card during the data exchange between the card and reader A potential spy E would only recover a signal s′+b′, which represents the transformed signal of signals s and b, which transit through the channel C. The signals a′ and b′ are different from s and b as they have undergone transformation, such as for example band-pass filtering due to the transmitting antennas in the case of RF waves.

The noise transmitted by means provided for this purpose of the receiver, has characteristics such that it is impossible to infer back to the transmitted data, object of signal s, only by knowing the signal s′+b′ propagating between the transmitter and the receiver in the channel C.

For this, the noise signal b has the following characteristics:

The noise signal b is independent of the transmitted data. Thus it is impossible to infer back to s or s′, starting with only the signal s′+b′.

Its spectral bandwidth covers that of the signal transmitted by the transmitter.

The amplitude of the noise power spectral density is larger than that of the signal in the useful bandwidth of the signal a. The useful bandwidth of the signal s is the frequency range strictly necessary for transmitting the signal. In this way, it is not possible to separate the noise signal with simple band-pass filters. For this, the noise power is such that the signal is buried in the noise, i.e., the noise amplitude is so large that the signal can no longer be extracted without a predetermined error rate on the extracted signal. For this, the signal-to-noise ratio S/B of the signal power Ps to the noise signal powers Pb is less than a predetermined level. It is preferable that the noise should not be reproducible therefore it will generally be random.

To summarize, the invention relates to a method for secured communication between a transmitter and a receiver in which a range of power levels transmitted by the transmitter, a frequency band inside which the transmission occurs, are known or detectable by the receiver, the method including
transmission by the receiver of a signal for supplying the transmitter with power,
characterized in that
the receiver transmits for at least the whole duration of the transmission, a noise signal independent of the transmitted data, with a spectral band which covers the frequency band inside which the transmission occurs, and with a power level such that the ratio between the signal level transmitted by the transmitter and the power level transmitted by the receiver is larger than a predetermined value,
the receiver subtracts from the received signal, the noise signal in order to obtain a useful signal.

The invention is particularly adapted to the field of contactless transmission for example if the transmitter is a chip card and the receiver is a chip card reader. The reader produces a signal supplying power to the card. The card has a transmission subcarrier frequency which is by convention known to the reader and which for example is a divided frequency or an integer multiple of the one of the tuned circuit of the reader. Generally, the card is introduced into a communications space provided in the reader for receiving the card. Introducing the card changes the added impedance in the circuits of the reader, so that detecting this change in impedance is information according to which a signal will be transmitted.

Preferably, the noise signal transmitted by the receiver is obtained by randomly modulating the signal supplying power to the transmitter by the receiver the modulation acting on the physical parameter, for example the phase, frequency amplitude, the same as the one modulated in the transmitted signal.

When the transmission signal is a digital signal with a bit period known beforehand it is advantageous to give a new random value to the modulated parameter of the noise signal, at each bit period of the transmitted signal and this synchronously with this signal. Thus, random drawing of the value of the selected parameter is performed synchronously with the bit period of the transmitted signal. As the modulation has a wide spectrum, it is certain that the spectral bandwidth of the scrambling noise is wider than the spectral bandwidth of the transmission signal, the power density being stronger in the vicinity of the carrier frequency of the transmission signal.

Preferably, the modulated parameter is a random variable which follows a Gaussian law or a uniform law with a mean of zero. Changing the electric power transmitted by the receiver to the transmitter is thereby avoided.

Preferably, the noise power level is determined according to a predetermined value in order to obtain a bit error rate larger than a predetermined value, in the absence of any knowledge on the noise signal transmitted by the receiver, which is the case of an intruder who attempts to sense the signal. When the transmission signal of the transmitter includes at least one transmission of a bit with a known value at a known instant, according to an advantageous alternative method of the invention, the transmission instants of the known values are used for evaluating the distortions undergone by the signals during transmission/reception.

During the other reception periods, an actual noise signal is calculated by using the previously evaluated distortions. This calculated noise signal is then subtracted from the received signal.

The invention also relates to a chip card reader device including means for generating a signal for supplying power to a transmitter of the card, for example a local oscillator, a space for receiving a card providing coupling between circuits borne by the card and transmission/reception means of the reader coupled with means for generating the power supply signal, characterized in that the receiver includes

means for modulating the power supply signal, which modulate the power supply signal,

a random signal generator coupled with said means for modulating the power supply signal,

means for processing the signal present on the transmission/reception means, these means being coupled with the random signal generator, with the transmission/reception means and with the modulation means, and including

subtraction means coupled with the antenna means and modulation means in order to subtract the modulation signal from the signal present on the transmission/reception means, and detection means coupled with the subtraction means in order to detect a useful signal.

In an alternative embodiment, the means for processing the signal present on the transmission/reception means include switching means with which, according to their position, the modulation signal may be subtracted, as indicated above, from the signal present on the transmission/reception means, or a known image of the useful signal may be subtracted from the signal present on the transmission/reception means.

### SHORT DESCRIPTION OF THE DRAWINGS

Exemplary embodiments of the method according to the invention and of the devices capable of achieving the method will now be described by means of the appended drawings wherein

FIG. 1 already described is an exemplary embodiment of a transceiver device known from the prior art wherein security of communication may be obtained by encryption of the transmitted data signal by the transmitter,

FIG. 2 already described is a more detailed exemplary embodiment than the one of FIG. 1 of a known transmitter from the prior art,

FIG. 3 already described is a diagram intended for explaining the principle on which the invention is based,

FIG. 4 illustrates a theoretical curve giving an average value of the number of false received bits relatively to the number of bits sent versus the ratio of the signal power over the noise power,

FIG. 5 illustrates a diagram intended for explaining the transformations undergone by the transmitted signal and by the noise transmitted by the receiver in a transmission channel between a transmitter and said receiver.

FIG. 6 illustrates a diagram as functional blocks of a receiver including means for modulating a power supply frequency intended for the transmitter and means for separating the noise of the receiver and a useful signal transmitted by the transmitter.

FIGS. 7a-7d illustrate time diagrams of signals.

FIG. 7a illustrates the useful signal s transmitted by a transmitter

FIG. 7b illustrates the current in the antenna 3 of the receiver in the absence of scrambling.

FIG. 7c illustrates the noise generated by a modulation circuit of the receiver.

FIG. 7d finally illustrates a current in an antenna of the receiver in the presence of the noise and of the useful signal.

FIGS. 8a-8e illustrate time diagrams of the different signals present during the processing of the combined signal: noise plus useful signal. It includes portions a-e.

FIG. 8a illustrates the useful signal as transmitted by the transmitter,

FIG. 8b illustrates the current present in the antenna of the reader in the absence of noise transmitted by the receiver,

FIG. 8c illustrates the current present in the antenna of the reader in the presence of noise transmitted by the receiver,

FIG. 8d illustrates the signal present in the means for processing the signal of the antenna of the receiver after subtracting the noise,

FIG. 8e illustrates the differential signal between the noiseless signal illustrated in portion d and the noise-suppressed signal i.e., the noise of which has been subtracted as illustrated in portion d.

In the drawings of the prior art or of the invention, the same reference numbers designate components with the same function.

### DETAILED DISCUSSION OF PARTICULAR EMBODIMENTS

A first exemplary embodiment of the method according to the invention will now be described for the case when the modulation of the signal s transmitted by the transmitter is binary phase shift keying modulation (BPSK).

Let fₚ be the carrier frequency of the signal s transmitted by the transmitter,

Let T be the duration off one bit (fₚ>>1/T)

Let V be the amplitude of the carrier frequency. The signal power spectral density Γ(f) is then:

$$Γ ( f ) = {V}^{2} \cdot T \frac{sin {c}^{2} ( [ f - {f}_{p} ] …T ) + sin {c}^{2} ( [ f + {f}_{p} ] \cdot T )}{4}$$

In this formula, sinc designates a cardinal sine according to the definition

$$Sinc ( x ) = cardinal sine ( x ) = \frac{sin \prod se}{\prod se}$$

The frequency band used by the signal has a width of 2/T and is centered around fₚ.
Let us assume a noise b(t) of the form:

$$b ( t ) = σ sin ( 2 π {f}_{p} t + φ ) {\sum }_{k = - ∞}^{+ ∞} {b}_{k} \cdot {Rect}_{T} ( t - kT )$$

$$with$$

$${Rect}_{T} ( t ) = \{ \begin{matrix}1 if t ∈ [ 0 , T ] \\ 0 else\end{matrix}$$

bₖ is a Gaussian random variable with zero mean and unit variance.

σ is a constant for adjusting the noise level.

This noise corresponds to adding a Gaussian noise to the symbols in the basic band.

The power spectral dispersion (PSD) Γ_{b}(f) of this noise is:

$${Γ}_{b} ( f ) = \frac{{σ}^{2} T}{4} ( sin {c}^{2} [ ( f - {f}_{p} ) \cdot T ] + sin {c}^{2} [ ( f + {f}_{p} ) \cdot T ]$$

The noise corresponds to a random sequence of modulation amplitudes. This noise added to the signal masks the amplitude of the transmitted signal.

Therefore one has the same PSD as for the signal s except that V is replaced with σ. The noise spectral band is therefore actually the same as that of the signal.

The minimum coefficient σ remains to be determined for the scrambling to be effective.

The theoretical curves known per se, giving the number of false received bits relatively to the number of sent bits (bit error rate or BER) versus the signal-to-noise ratio V²/σ² (ratio of the signal power over the noise power) is illustrated in FIG. 4. The BERs are plotted in ordinates and the signal/noise ration values in DB are plotted in abscissae. The noise power to be sent is inferred from this curve in order to obtain the desired error rate.

Thus, if it is desired that the eor rate be larger than 0.3, the signal-to-noise ratio should be less than −5.7 dB (a noise power 3.7 times greater than that of the signal). Therefore, if V=1 volt; σ should be \sqrt{3.7}≈1.9 volts.

Generally, it is preferable that the noise power level be determined according to a predetermined value in order to obtain a bit error rate larger than a predetermined value in the absence of knowledge on the noise signal transmitted by the receiver.

In order that the noise should not be reproducible by two similar receivers, it is preferable that it be random.

Generating the noise is performed by means of random phenomenon, for example noise in a function of a transistor, in order to prevent the same noise to be generated by a third party.

It is then obvious that two identically manufactured receivers do not generate the same noise signal since this noise is thermal noise in the example. This means that there must be a real random phenomenon depending on the outside world, at the noise generation source.

In order that the noise should be unpredictable, and that the future noise only depends on the past noise, logic circuits which provide pseudo-random phenomena should not be used but rather signals of physical origin such as the thermal noise of a transistor should be used. Indeed, according to the communications protocol used, the signal s transmitted by the transmitter may be known at certain instants, if the future noise only depended on the past noise, then the noise during these periods and subsequently the whole noise chain would be able to be inferred from this.

The method for eliminating the noise by the receiver in order to recover the transmitted signal s is now tackled.

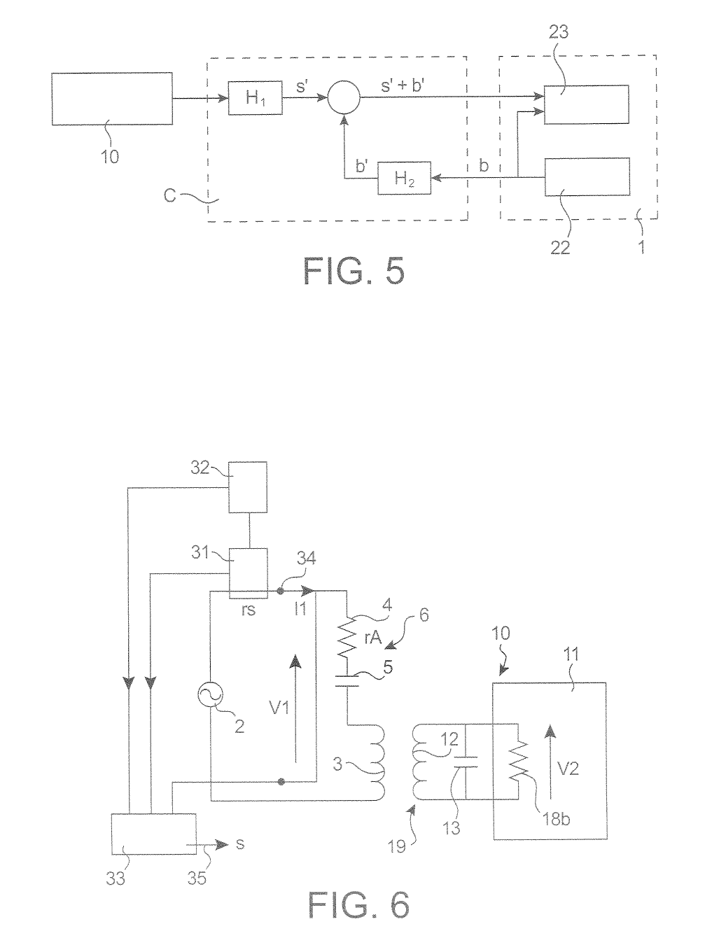

Between its transmission by the receiver and its reception by the detection circuit of the receiver, the noise signal has undergone various convolutions due to the electronics and to the transmission channel C as schematized in FIG. 5. This figure schematically Illustrates the transmitter 10 the channel C and the receiver 1. The receiver 1 includes a transmitter 22 of the noise b and a receiver 23 of the noise b′ and of the signal s′, which respectively are a transform of the noise b by a convolution H1 in channel C and a transform of the signal s by a convolution H1 in channel C. For the sake of simplification all the convolutions of the noise have been reduced to a single convolution H2 in the channel.

In order that the receiver may eliminate b′ by knowledge of b, it must estimate the convolution H2. This estimation may for example be performed during an initialization phase of the communication.

As the communication is contactless, the filter H₂ may change during the communication. Therefore the change of this filter during the communication should preferably be tracked.

A particular hardware embodiment of the invention will now be described with reference to FIG. 6. FIG. 6 illustrates a diagram as functional blocks of a receiver/transmitter system like the one illustrated in FIG. 1. The receiver is improved in order to apply the invention. With respect to the circuit illustrated in FIG. 1, the detection circuit 7-9 is replaced with a module 33 for separating the noise b′ and the useful signal s′. The circuit further includes a circuit 31 for modulating a power supply frequency intended for the transmitter, the means 33 for separating the noise of the receiver and a useful signal transmitted by the transmitter, and a random signal generator 32. The means 33 for separating the noise of the receiver and the useful signal transmitted by the transmitter are coupled with the modulation circuit 31 so that it receives the modulation signal produced by this circuit 31 on the one hand, and with a point 34 of the receiver circuit on the other hand where the signal transmitted by a transmitter 10 and received by magnetic coupling at the antenna 3 of the receiver 1 is resent. The signal borne by the antenna 33 is representative of a combination of noise signals and of a useful signal, received by the receiver 1.

The means 33 for separating the noise of the receiver and the useful signal are coupled with the random signal generator. By means of this connection, a change in the impedance of the tuned circuit 6 due to the introduction of a card bearing a transmitter circuit in the receiver 1, is detected and transmitted to the random signal generator 32. The random signal generator 32 is coupled with means 33 for separating the noise of the receiver and the useful signal.

The operation is the following. When a card bearing a transmitter 10 is introduced in a space reserved for this purpose in the reader 1, it produces a change in the impedance of the tuned circuit 6 which is detected by the means 33. This detection causes the means 33 to transmit a signal for enabling the random noise generator 32. The random noise produced by the random noise generator 32 is received by the modulation circuit 31 and is used by this circuit in order to modulate the carrier frequency transmitted by the carrier frequency generator 2. This modulation may assume the form, as illustrated in FIG. 6, of a modulation of the value of a resistance rs loading the resonance circuit 6 in addition to the load rA 4. This case corresponds to amplitude modulation. If the signal transmitted by the transmitter 10 is phase-modulated or frequency-modulated, the output 34 of the modulator 31 is applied to a phase or frequency modulator circuit, respectively. Such phase or frequency modulation circuits are known per se. The random noise is sufficient for raising the signal/noise ratio present in the channel C to a sufficient level in order to bury the useful signal as explained earlier. The means 33 which separately receive the modulation representative of the noise from the modulation circuit 31 and the scrambled useful signal s′+b′ present on the antenna 3, separate the noise from the useful signal for example by subtraction and deliver the useful signal a to an output 35.

In the illustrated example, the emitter 10 is a remotely powered contactless card and the receiver 1 is an RF wave card reader, the receiving frequency is fc=13.56 MHz. The purpose is to scramble the transmission of the transmitter 10 of the card. The transmitter 10/receiver 1 system operates in a way known per se according to the protocol defined by the ISO 14443 standard for chip cards without any close contact:

As a reminder, according to this standard

The lowest binary rate is f_{c}/128 (˜106 kbit/s).

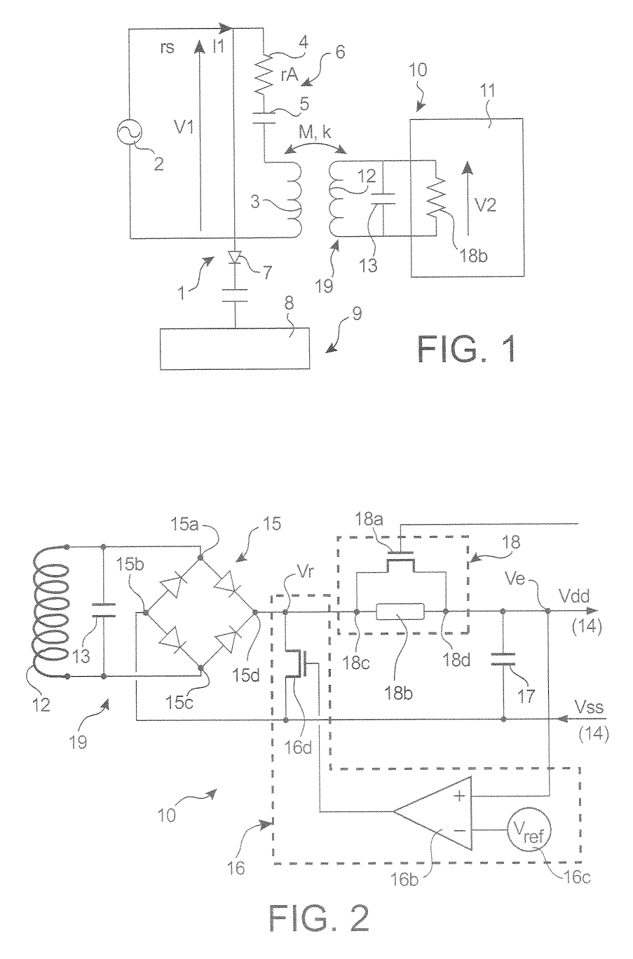

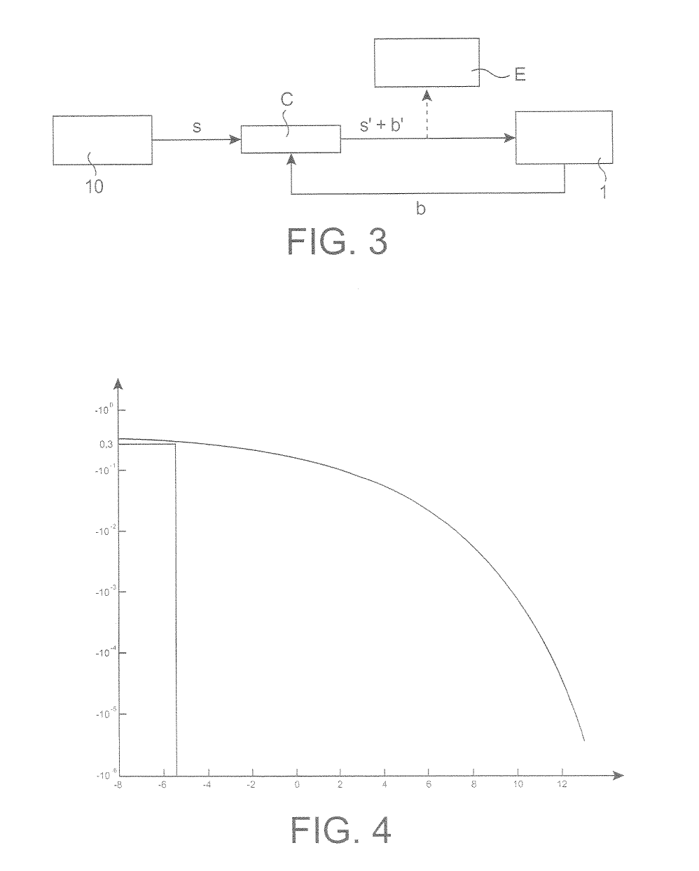

The transmitter 10 of the card sends information to the reader 1 by load modulation for example as described earlier in connection with the prior art illustrated in FIG. 2: the reader 1 sends a non-modulated f_{c}=1356 MHz signal. This signal is produced by the antenna which receives the signal generated by the frequency generator 2, for example an oscillator 2. The transmitter 10 of the card Generates a subcarrier of frequency

$${f}_{s} = \frac{{f}_{c}}{16} = 847.5 kHz$$

by modulating its load.

The subcarrier is BPSK modulated: one bit corresponds to 8 periods of the subcarrier.

The transmitter 10 of the card begins its transmission with a subcarrier of phase Φ₀ for a period TR1. This phase Φ₀ corresponds to a <<1>>. The phase Φ₀+180° corresponds to a <<0>>.

The noise generated by the generator 32 is such that it prevents the detection of the phase of the subcarrier. It is assumed that the modulation of the load 18b of the card 10, in order to generate the useful signal s, will induce an amplitude modulation. This modulation is induced by a change in the resistance 18b illustrated in FIGS. 2 and 6. The receiver 1 according to the invention modulates the 13.56 MHz carrier in amplitude with a square signal of frequency

$${f}_{s} = \frac{{f}_{c}}{16} = 847.5 kHz$$

and with random amplitude (an amplitude which may also assume negative values). The amplitude of the subcarrier

$${f}_{s} = \frac{{f}_{c}}{16}$$

is randomly drawn every time a bit is transmitted by the random signal generator 32.

Thus, the generated noise occupies the same spectral band as the useful signal. If it is assumed that the algebraic amplitude of the subcarrier follows a Gaussian law, the variance of this amplitude is selected as explained earlier in connection with FIG. 4, so as to have a bit error rate of more than 30%. The variance of the modulation index, of the noise, should be larger than 3.7 times the square of the modulation index of the signal. As a reminder, the modulation index of the noise is proportional to the amplitude of the subcarrier for a given carrier amplitude.

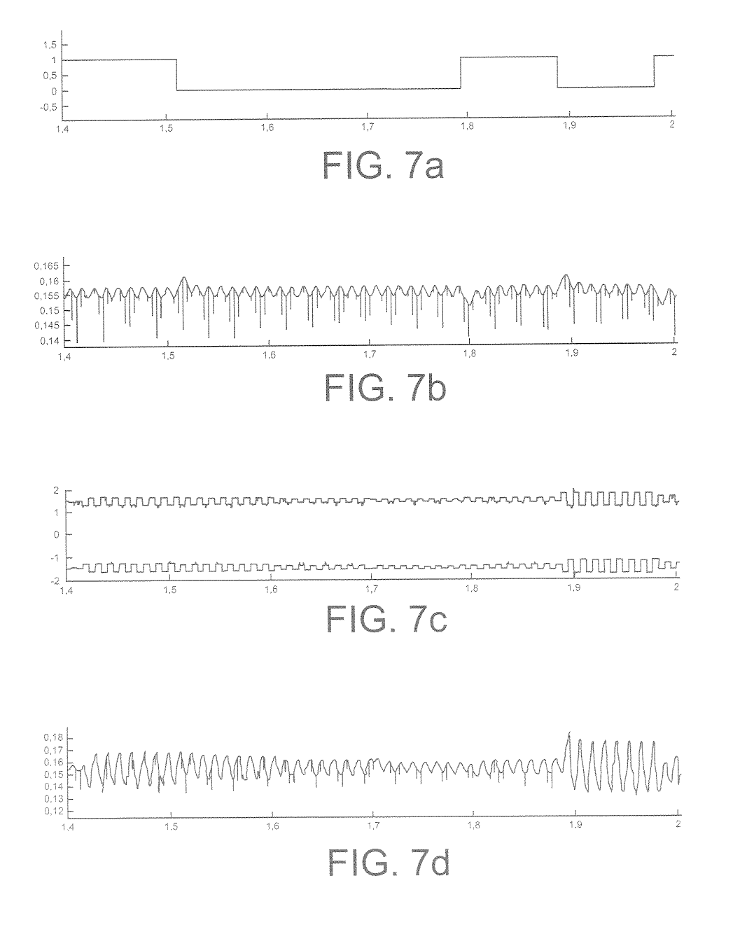

Comments on the results will now be given in connection with FIG. 7. This figure illustrates signal time diagrams. It includes portions a-d.

Portion a illustrates the useful signal s transmitted by the transmitter card 10. This is an impulse signal assuming the logic values 1 and 0.

Portion b illustrates the current in the antenna 3 of the receiver in the absence of scrambling. As the modulation is a BPSK modulation the signal is <<carried >> here by the phase of the subcarrier. As explainer earlier, the phase Φ₀ corresponds to a <<1 >> and the phase Φ₀+180′ corresponds to a <<0 >>

Portion c illustrates the noise generated by the modulation circuit 31 controlled by the random signal generator 32.

Finally, portion d illustrates the current in the antenna in the presence of noise and of the useful signal.

For the simulation plot of the graphs of FIG. 7 the variance of the modulation index of the generated noise was (10%)² whereas the modulation index of the noiseless received signal was about 1%. The simulated distance from the reader 1 to the card bearing the transmitter 10 was about 4 cm. The signal-to-noise ratio was therefore −20 dB which corresponds to a bit error rate of about 45%.

The electromagnetic field present at the antenna 3 is the field resulting from the fields generated by the reader 1 and the card 10. The noise field generated by the reader 1 is much more stronger than the one generated by the useful signal of the card 1. In the resulting field, the useful signal bearing the data to be transmitted is masked by the noise signal.

However, it should be noted that by placing oneself at a very small distance from the card relatively to the distance between the reader and the card, the field generated by the card is predominant. But, because of its nature, the card is in motion when it is used, and may be found anywhere in the operating space of the reader 1. Consequently, it is therefore impossible to place a spy device which would be much closer to the card than to the reader.

For subtracting the noise b′ from the combined signal of the noise and the useful signal, a′+b′, with the shape of the generated noise, it is possible to avoid estimating the H₂ filter described earlier. Over a period of one bit, the noise is proportional to the following signal:
b₀(t)=c(t+σ)·cos(2πft+φ)
wherein c(t) is a periodic square signal varying from +1 to −1 with a period 1/fₛ. The constant τ depends on the initial instant. Therefore one has:
b(t)=K·b₀(t)
wherein K is a random number with a uniform probability density between −a and +a. For example, if the carrier has a non-modulated amplitude of 1 V, then a=0.2 V is selected in order to have a modulation index of 20%.

The number K is randomly drawn in the random signal generator 32 for each bit sent by the transmitter 10 of the card and is known to the reader and only to it, since it is received at the means 33.

The mean value of the amplitude of the noise signal sent by the reader 1 is constant over time as the mean value of the amplitude shift induced by the noise is zero. The influence of this noise on the parameters for regulating the voltage of the card 10 for it to be powered remotely, may therefore in a first approximation be neglected. In this case, the system is linear.

Thus, by the linearity of the system upon it returning to the readers the noise has become:
b′(t)=K·b₀′(t)

Therefore knowledge of b₀′(t) is sufficient in order to succeed in subtracting the noise.

The receiver digitizes the signal with a sampling frequency fₑ. With the following initialization sequence, the reference noise may be recorded:
No noise for at least one bit (K=0) and the signal a recorded.
K=Ko for at least one bit and the transmitter 10 of the card sends the same bit as in the previous step. Subtraction of this received signal by the one of the previous step is performed and the whole is divided by K₀. The reference noise is thereby obtained and stored.

This sequence may be performed during the period TR1 described earlier.

Next, the reader knowing K, the subtraction of the noise is performed for example by phase inversion of the noise signal, multiplication by K and addition to the combined signal. This method has the advantage of having a limited number of operations to be performed.

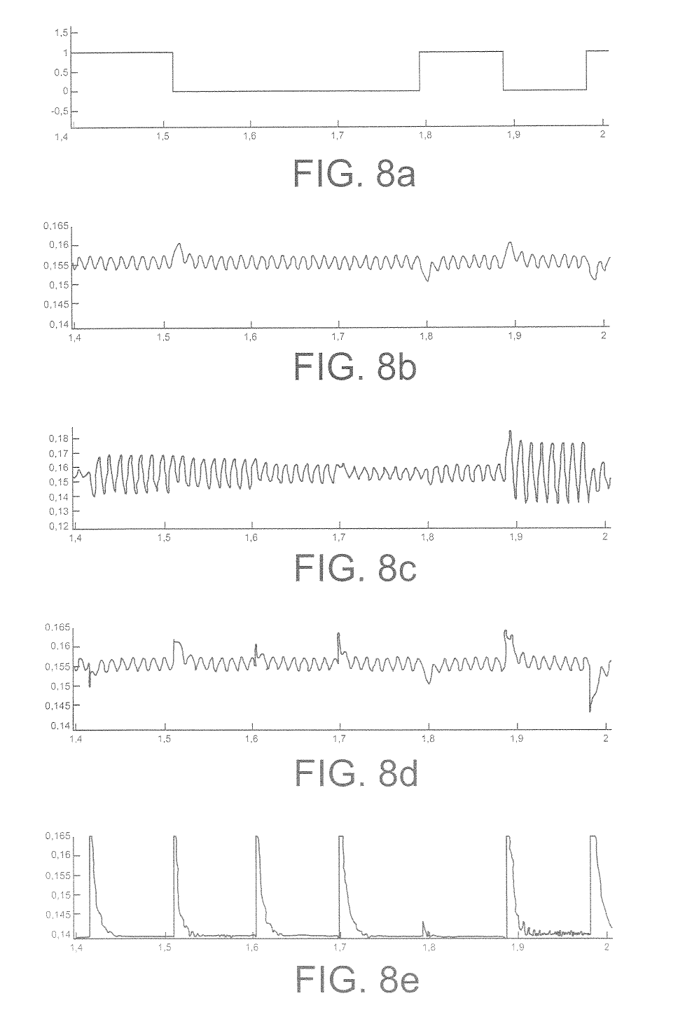

FIG. 8 illustrates time diagrams of different signals present during the processing of the combined signal, noise plus useful signal. It includes portions a-e.

In portion a, the useful signal is illustrated as transmitted by the card 10.

In portion b, the current present in the antenna of the reader 1 is illustrated in the absence of noise transmitted by the receiver 1.

In portion c, the current present in the antenna 3 of the reader 1 is illustrated, in the presence of noise transmitted by the receiver 1.

In portion d, the signal present in the means 33 for processing the signal of the antenna 3 after subtraction of the noise is illustrated.

In portion e, is illustrated the differential signal between the noiseless signal illustrated in portion b and the noise-suppressed signal i.e., the noise of which has been subtracted as illustrated in portion d.

In FIG. 8, it is possible to compare the noiseless signal illustrated in portion b with the noisy one from which the noise illustrated in portion d has been subtracted. This difference is illustrated in portion e. The sampling frequency used is 4×f_{c}. It is noted that at the beginning of each bit, the difference is rather significant but it decreases very rapidly. This difference is due to the interfaces between the successive pairs (bit; noise) (overall response time of the system). When the level is stabilized, i.e., very shortly after the beginning of the bit, the residual noise has an amplitude such that the modulation index which it induces, is less than 0.1%. This is expressed by the fact that on curve e, the differential signal at the beginning of each bit has a relatively large amplitude which is almost brought back to 0 after about ⅕ of the duration of one bit.

During a communication, the reference noise may change with the motion of the card 10 relatively to the reader 1, and the record therefore needs to be adapted. The protocol described in the ISO 14443 standard provides that each byte is surrounded with a bit set to 0 and a bit set to 1. These known bits may be used for updating the recorded reference noise.

1-7. (canceled)

8: A method for secured communication between a transmitter and a receiver, wherein a range of power levels transmitted by the transmitter a band of frequencies inside which the transmission occurs, are known or detectable by the receiver, the method comprising:
transmitting by the receiver a signal for powering the transmitter;
transmitting by the transmitter a useful data signal by modulating a parameter of a carrier frequency of the useful data signal;
wherein the receiver transmits for at least the whole duration of the transmission of the useful data signal from the transmitter a noise signal independent of the transmitted data, having a spectral band that covers the frequency band inside which transmission occurs, and having a power level such that the ratio between the data signal level transmitted by the transmitter and the power level transmitted by the receiver is larger than a predetermined value, and
the receiver subtracts the noise signal from the received signal to obtain the transmitted useful data signal.

9: The method for secured communication between a transmitter and a receiver according to claim 8, wherein the noise signal transmitted by the receiver is obtained by random modulation of the signal for supplying power to the transmitter by the receiver, a modulation applied to the same parameter as the modulating used for the transmission signal.

10: The method for secured communication between a transmitter and a receiver according to claim 9, wherein the transmission signal is a digital signal with a bit period known beforehand, and random drawing of the value of the parameter on which the noise modulation is applied is performed synchronously with the transmitted signal.

11: The method for secured communication between a transmitter and a receiver according to claim 10, wherein the modulation of the parameter on which the noise modulation is applied follows a Gaussian law or a uniform law with zero mean.

12: The method for secured communication between a transmitter and a receiver according to claim 8, wherein the noise level is determined according to a predetermined value to obtain in the absence of knowledge on the noise signal transmitted by the receiver, a bit error rate larger than a predetermined value.

13: The method for secured communication between a transmitter and a receiver according claim 10, wherein the transmission signal of the transmitter includes at least one transmission of a bit of known value at an instant known to the receiver and of bits of unknown value at other instants of transmission,
wherein the known instants of transmission of a bit with a known value are used for evaluating distortions of the signals during transmission/reception, the evaluated distortions being used during the other instants for calculating a real noise signal that becomes the noise signal that is subtracted from the signal received by the receiver.

14. A reader of a chip card comprising:
means for generating a power supply signal for powering a transmitter of the card;
a space for receiving a card providing coupling between circuits borne by the card; and
transmission reception means of the reader coupled with the means for generating the power supply signal,
wherein the receiver includes
means for modulating the power supply signal,
a random signal generator coupled with said means for modulating the power supply signal,
means for processing the signal received by the receiver, being coupled with the random signal generator, with the transmission/reception means and with the modulation means, the means for processing the received signal by the receiver separating the signal present on the transmission reception means and the modulation signal, to recover a useful signal transmitted by the transmitter of the card.
